(19) United States
(12) Patent Application Publication
(10) Pub. No.: US 2026/0154768 A1
(43) Pub. Date: Jun. 4, 2026

(54) METHODS, SYSTEMS, AND STORAGE MEDIA FOR EMERGENCY SUPERVISION OF OPEN FLAME AREAS IN SMART CITIES BASED ON INTERNET OF THINGS LARGE MODELS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Guobin LUO, Chengdu (CN)

(73) Assignee: CHENGDU QINCHUAN IOT TECHNOLOGY CO., LTD., Chengdu (CN)

(21) Appl. No.: 19/460,295

(22) Filed: Jan. 26, 2026

(30) Foreign Application Priority Data
Dec. 8, 2025 (CN) 202511833223.0

(51) Int. Cl. G06Q 50/26; B64U 20/80; B64U 101/30; B64U 101/35; G05B 13/02; G05D 1/689; G05D 7/06; G05D 105/80; G05D 109/20; G06Q 10/0635

(52) U.S. Cl. CPC G06Q 50/265; B64U 20/80; G05B 13/0265; G05D 1/689; G05D 7/0635; G06Q 10/0635; B64U 2101/30; B64U 2101/35; G05D 2105/89; G05D 2109/20

(57) ABSTRACT

A system and a method for emergency supervision of an open flame area in a smart city based on an IoT large model are provided. The system includes an emergency supervision management platform configured to: determine a first hazardous area based on a gas output flow rate of at least one gas storage tank and a gas usage flow rate of at least one gas device in at least one area; control a UAV to travel to the first hazardous area based on a UAV acquisition command, and acquire a device image sequence; determine, based on the device image sequence, a flame feature through a feature recognition large model; determine an explosion risk of the first hazardous area based on the flame feature and an air flow rate; and determine a valve closure command based on the explosion risk, and close a target valve based on the valve closure command.

### CROSS-REFERENCE TO RELATED APPLICATIONS

This application claims priority to Chinese Patent Application No.202511833223.0, filed on Dec. 8, 2025, the entire contents of each of which are hereby incorporated by reference.

### TECHNICAL FIELD

The present disclosure relates to a field of gas safety, and in particular to a method, a system, and a storage medium for emergency supervision of an open flame area in a smart city based on an Internet of Things (IoT) large model.

### BACKGROUND

With the advancement of smart city construction, there is an increasingly urgent need for emergency management of gas safety. With development of IoT technology, monitoring of gas usage scenarios has gradually transformed towards intelligence and automation. However, traditional gas monitoring manners have deficiencies in distinguishing between normal open flame usage and potential explosion hazards, are prone to misjudgments, and struggle to effectively respond to complex gas safety risks.

Therefore, it is necessary to provide a method, a system, and a storage medium for emergency supervision of an open flame area in a smart city based on an IoT large model, to accurately identify open flame usage features, monitor behavioral features of individuals and gas filling features, and timely remotely control relevant devices to reduce gas explosion risks.

### SUMMARY

One or more embodiments of the present disclosure provide a system for emergency supervision of an open flame area in a smart city based on an Internet of Things (IoT) large model. The system comprises an emergency supervision management platform. The emergency supervision management platform is configured to execute a method for emergency supervision of an open flame area in a smart city based on an IoT large model.

One or more embodiments of the present disclosure provide a method for emergency supervision of an open flame area in a smart city based on an IoT large model. The method is executed by an emergency supervision management platform of a system for emergency supervision of an open flame area in a smart city based on the IoT large model. The method comprises: determining a first hazardous area based on a gas output flow rate of at least one gas storage tank and a gas usage flow rate of at least one gas device in at least one area; generating an Unmanned Aerial Vehicle (UAV) acquisition command based on the first hazardous area; controlling a UAV to travel to the first hazardous area based on the UAV acquisition command, and acquiring a device image sequence; determining, based on the device image sequence, a flame feature through a feature recognition large model, wherein the feature recognition large model is a machine learning model; determining an explosion risk of the first hazardous area based on the flame feature and an air flow rate; and determining a valve closure command based on the explosion risk, and closing a target valve based on the valve closure command.

One or more embodiments of the present disclosure provide a non-transitory computer-readable storage medium. The storage medium stores computer instructions. When a computer reads the computer instructions in the storage medium, the computer executes a method for emergency supervision of an open flame area in a smart city based on an IoT large model.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a structural diagram illustrating exemplary platforms of a system for emergency supervision of an open flame area in a smart city based on an IoT large model according to some embodiments of the present disclosure;

FIG. 2 is a flowchart illustrating an exemplary process of a method for emergency supervision of an open flame area in a smart city based on an IoT large model according to some embodiments of the present disclosure;

FIG. 3 is a schematic diagram illustrating an exemplary process for determining an explosion risk according to some embodiments of the present disclosure; and

FIG. 4 is a flowchart illustrating an exemplary process for determining a target purging device according to some embodiments of the present disclosure.

### DETAILED DESCRIPTION

To more clearly illustrate the technical solutions in the embodiments of the present disclosure, the drawings used in the description of the embodiments will be briefly introduced below. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof. The term “and/or”, as used herein, is merely a way of describing the associative relationship of an associated object, indicating that three relationships can exist, e.g., A and/or B, which may be represented as: An alone, both A and B, and B alone.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

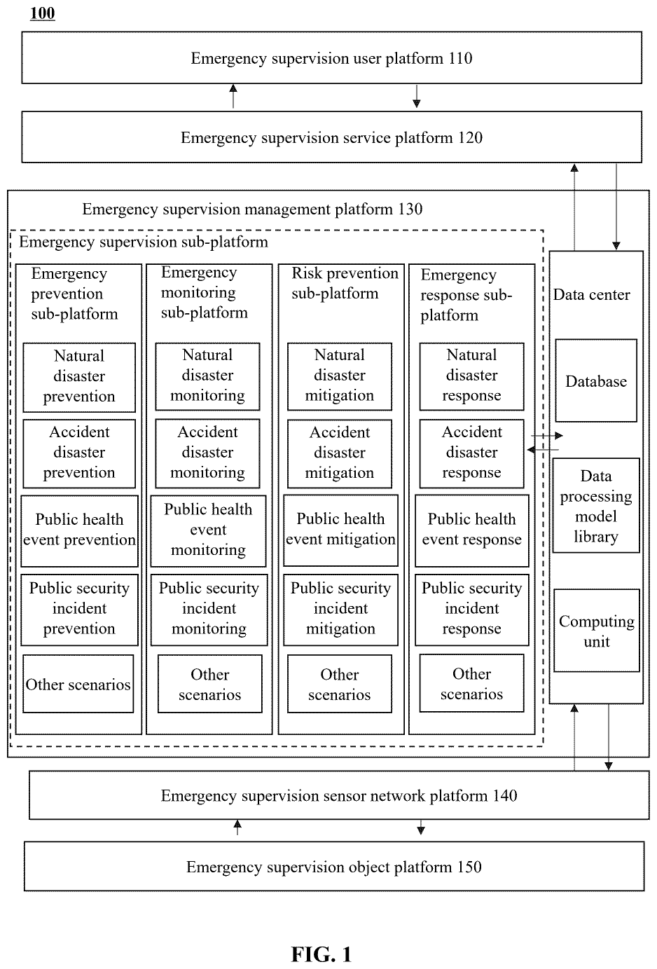

FIG. 1 is a structural diagram illustrating exemplary platforms of a system for emergency supervision of an open flame area in a smart city based on an IoT large model according to some embodiments of the present disclosure.

In some embodiments, as shown in FIG. 1, a system 100 for emergency supervision of an open flame area in a smart city based on an IoT large model (hereinafter referred to as the system 100 or the emergency supervision system 100) includes an emergency supervision user platform 110, an emergency supervision service platform 120, an emergency supervision management platform 130, an emergency supervision sensor network platform 140, and an emergency supervision object platform 150.

The emergency supervision user platform 110 refers to a platform for comprehensive coordination of emergency supervision by a superior department. In some embodiments, the emergency supervision user platform may include at least one user interaction device. For example, the user interaction device includes a mobile phone, a computer, or the like.

The emergency supervision service platform 120 refers to an interactive service platform for receiving and transmitting data.

In some embodiments, the emergency supervision service platform may be configured as a server, which may perform data interaction with the emergency supervision user platform upstream and perform data interaction with the emergency supervision management platform downstream.

The emergency supervision management platform 130 refers to a comprehensive platform for processing and managing emergency supervision data.

In some embodiments, the emergency supervision management platform may be configured in a processor and/or a server. The processor and/or server may process data and/or information obtained from other platforms. The processor and/or server may execute program instructions based on the data, information, and/or processing results to perform one or more functions described in the present disclosure.

In some embodiments, the emergency supervision management platform includes an emergency supervision sub-platform and a data center.

In some embodiments, the emergency supervision sub-platform includes at least one of an emergency prevention sub-platform, an emergency monitoring sub-platform, a risk prevention sub-platform, and an emergency response sub-platform.

The emergency prevention sub-platform refers to a management platform for assessing and preventing emergency events. For example, the emergency prevention sub-platform may be configured to perform prevention tasks for natural disasters, accident disasters, public health events, public security incidents, and other scenarios requiring emergency prevention.

The emergency monitoring sub-platform refers to a platform for monitoring, collecting, and analyzing emergency event data. For example, the emergency monitoring sub-platform may be configured to perform monitoring of natural disasters, accident disasters, public health events, public security incidents, and other scenarios requiring emergency monitoring.

The risk prevention sub-platform refers to a platform for identifying potential risks, assessing risk levels, and implementing risk reduction strategies. For example, the risk prevention sub-platform may be configured to perform risk mitigation for natural disasters, accident disasters, public health events, public security incidents, and other scenarios requiring risk mitigation.

The emergency response sub-platform refers to a platform for coordinating, dispatching, and executing emergency plans after an emergency event occurs. For example, the emergency response sub-platform may be configured to execute response operations for natural disasters, accident disasters, public health events, public security incidents, and other scenarios requiring emergency response.

In some embodiments, the data center includes a database, a data processing model library, and a computing unit.

The database is configured to collect, store, and manage a large amount of data related to emergency management. For example, the database includes MySQL, PostgreSQL, InfluxDB, Prometheus, or the like.

The data processing model library refers to a collection of data processing models for emergency management data processing.

The computing unit refers to a functional module for performing arithmetic, logic, and other instruction operations. The computing unit include, but is not limited to, a central processing unit (CPU), or the like.

In some embodiments, the emergency supervision management platform interacts with the emergency supervision service platform upstream and interacts with the emergency supervision sensor network platform downstream.

In some embodiments, the emergency supervision management platform is configured to: determine a first hazardous area based on a gas output flow rate of at least one gas storage tank and a gas usage flow rate of at least one gas device in at least one area; generate an Unmanned Aerial Vehicle (UAV) acquisition command based on the first hazardous area; control a UAV to travel to the first hazardous area based on the UAV acquisition command, and acquire a device image sequence; determine, based on the device image sequence, a flame feature through a feature recognition large model, wherein the feature recognition large model is a machine learning model; determine an explosion risk of the first hazardous area based on the flame feature and an air flow rate; and determine a valve closure command based on the explosion risk, and close a target valve based on the valve closure command.

The emergency supervision sensor network platform 140 refers to a management platform for transmitting sensor data or information related to emergency supervision. In some embodiments, the emergency supervision sensor network platform may include a communication device, a server, various types of gateway devices, or the like.

In some embodiments, the emergency supervision sensor network platform interacts with the emergency supervision management platform upstream and interacts with the emergency supervision object platform downstream.

The emergency supervision object platform 150 refers to a platform for collecting emergency supervision data and implementing execution instructions. In some embodiments, the emergency supervision object platform 150 may include various types of monitoring, sensing, and interactive devices, e.g., a gas storage tank, a UAV, a gas valve, a pressure sensor, a liquid level sensor, or the like.

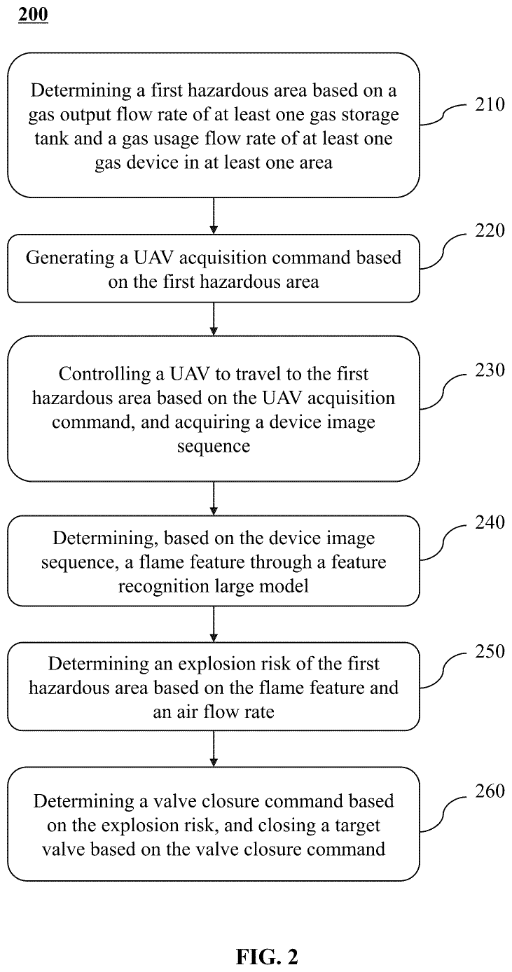

In some embodiments, more detailed descriptions regarding the system 100 and a method for emergency supervision of an open flame area in a smart city based on an IoT large model may be found in FIG. 2 to FIG. 4 and relevant descriptions thereof.

It should be noted that the above description of the system 100 for emergency supervision and its modules is merely for convenience of description and cannot limit the present disclosure to the scope of the illustrated embodiments. It may be understood that for those skilled in the art, after understanding the principle of the system, various modules may be combined arbitrarily or form subsystems to connect with other modules without departing from this principle. In some embodiments, the emergency supervision user platform 110, the emergency supervision service platform 120, the emergency supervision management platform 130, the emergency supervision sensor network platform 140, and the emergency supervision object platform 150 disclosed in FIG. 1 may be different modules in one system, or one module may implement the functions of two or more of the above modules. For example, each module may share one storage module, or each module may have its own storage module respectively. Such modifications are within the protection scope of the present disclosure.

FIG. 2 is a flowchart illustrating an exemplary process of a method for emergency supervision of an open flame area in a smart city based on an IoT large model according to some embodiments of the present disclosure. As shown in FIG. 2, a process 200 includes the following operations. In some embodiments, the process 200 may be executed by an emergency supervision management platform (e.g., the emergency supervision management platform 130).

In 210, a first hazardous area may be determined based on a gas output flow rate of at least one gas storage tank and a gas usage flow rate of at least one gas device in at least one area.

The gas output flow rate of a storage tank refers to a speed at which gas flows out from an outlet of the gas storage tank. In some embodiments, for a centralized gas supply scenario, the gas output flow rate may include an output flow rate of a main gas control valve, or the like.

The gas usage flow rate of a gas device refers to a speed at which gas is consumed after entering the gas device.

In some embodiments, the gas storage tank and the gas device are pre-connected to an IoT, and the emergency supervision management platform may obtain the gas output flow rate of the gas storage tank and the gas usage flow rate of the gas device through an emergency supervision object platform (e.g., the emergency supervision object platform 150).

The first hazardous area refers to an area that requires detailed inspection and may have hazards such as gas leakage. For example, the first hazardous area includes back kitchens of a plurality of restaurants or food courts in a residential area or a commercial complex.

In some embodiments, the emergency supervision management platform may pre-divide a management area into a plurality of areas according to a preset division rule. Taking application to the management of a commercial complex as an example, the emergency supervision management platform may perform area division in a plurality of ways. For example, one commercial complex corresponds to one area. As another example, one floor in one commercial complex corresponds to one area.

In some embodiments, for each area among a plurality of areas, the emergency supervision management platform may determine a difference between a total gas output flow rate of all gas storage tanks and a total gas usage flow rate of all gas devices in the area, and determine an area in which the difference is greater than a first threshold as the first hazardous area. The first threshold may be set by a technician based on experience.

In 220, a UAV acquisition command may be generated based on the first hazardous area.

The UAV acquisition command refers to a command for a UAV to perform acquisition on a target area. The target area refers to an area from which the UAV needs to acquire data. In some embodiments, the UAV acquisition command may include a travel path, the target area, acquisition parameters of the UAV. In some embodiments, the acquisition parameters may include, but are not limited to, a sampling height, a sampling time, an acquisition frequency, a sensor type, etc. The acquisition parameters may be obtained by querying a preset table based on the target area.

In some embodiments, the emergency supervision management platform may determine the first hazardous area as the target area of the UAV, and determine the travel path and the acquisition parameters of the UAV based on the first hazardous area, thereby generating the UAV acquisition command.

In 230, a UAV may be controlled to travel to the first hazardous area based on the UAV acquisition command, and a device image sequence may be acquired.

The device image sequence refers to a continuous image set obtained by arranging images of the gas device captured in chronological order. In some embodiments, the device image sequence may include device images of the gas device at a plurality of time points.

In some embodiments, the emergency supervision management platform may control the UAV to travel to the first hazardous area based on the UAV acquisition command, and capture images of the gas device in the first hazardous area through a camera mounted on the UAV, thereby acquiring the device image sequence.

In 240, a flame feature may be determined based on the device image sequence through a feature recognition large model.

The flame feature refers to a parameter that characterizes whether a flame exists in the first hazardous area and a status of the existing flame. In some embodiments, the flame feature includes a flame height, a flame burning duration, etc. The flame burning duration refers to the length of time a currently still-burning flame has been continuously monitored, e.g., the time elapsed from the initial emergence of the flame until a last time point in the device image sequence, etc.

In some embodiments, the emergency supervision management platform may identify the device image sequence through the feature recognition large model to determine the flame feature.

The feature recognition large model refers to a model configured to extract the flame feature from the device image sequence acquired by the UAV. In some embodiments, the feature recognition large model is a machine learning model. For example, the feature recognition large model may include any one of a Convolutional Neural Network (CNN) model, a customized model structure, or the like, or any combination thereof.

In some embodiments, an input of the feature recognition large model may include the device image sequence, and an output may be the flame feature.

In some embodiments, the feature recognition large model may be obtained by training using a large number of first training samples with first labels. In some embodiments, the first training sample may include a sample device image sequence, and the first label may be a flame feature corresponding to the first training sample. In some embodiments, the first training sample may be obtained based on historical data, and the first label corresponding to the first training sample may be obtained by manual annotation.

In some embodiments, the emergency supervision management platform may perform training through various manners based on the first training sample and the first label. For example, the training may be performed based on a gradient descent manner. Merely by way of example, a plurality of first training samples with first labels may be input into an initial feature recognition large model, a loss function may be constructed based on the first labels and a result of the initial feature recognition large model, and parameters of the initial feature recognition large model may be iteratively updated based on the loss function. When the loss function of the initial feature recognition large model satisfies a preset condition, the model training is completed, and a trained feature recognition large model is obtained. The preset condition may include convergence of the loss function, the count of iterations reaching a threshold, etc.

In 250, an explosion risk of the first hazardous area may be determined based on the flame feature and an air flow rate.

The explosion risk refers to a measure of a possibility of gas explosion.

In some embodiments, the emergency supervision management platform obtains the flame height and the flame burning duration based on the flame feature, determines a flame feature in which the flame height is greater than a preset threshold and the flame burning duration is less than a preset duration threshold as a target flame feature, then performs normalization processing on the flame height and the air flow rate corresponding to the target flame feature, and determines a weighted value obtained through weighted calculation as the explosion risk of the first hazardous area, wherein weights may be set based on experience.

In 260, a valve closure command may be determined based on the explosion risk, and a target valve may be closed based on the valve closure command.

The valve closure command refers to a command that triggers a valve to perform a closing operation. In some embodiments, the valve closure command includes the target valve, etc.

The target valve refers to a valve that needs to perform the closing operation based on an explosion risk assessment result. In some embodiments, the target valve may include a valve of a gas storage tank, a gas valve connected to a gas device, etc.

In some embodiments, the emergency supervision management platform may determine a risk control area based on the explosion risk, and determine all gas valves connected to the gas device and valve(s) directly connected to the gas storage tank(s) in the risk control area as target valves.

For example, the emergency supervision management platform may determine an area in which the explosion risk is greater than a preset risk threshold as a control area, determine the control area and an area directly adjacent to the control area as the risk control area, and generate the valve closure command to close all gas valves in the risk control area.

In some embodiments, based on the explosion risk, the emergency supervision management platform may determine all gas valves connected to the gas device(s) and valves directly connected to the gas storage tank(s) in the first hazardous area as the target valves.

Merely by way of example, in a food court scenario of a commercial complex where a plurality of food stalls use liquefied petroleum gas cylinder gas storage tanks. When the emergency supervision management platform detects an abnormal difference between the gas output flow rate of at least one gas storage tank and the gas usage flow rate of at least one gas device in the food court, it indicates a potential gas leakage risk, and the emergency supervision management platform immediately determines the food court as the first hazardous area. Since at least one gas device is still operating, leaked gas may cause an explosion accident when encountering an open flame. At this time, the emergency supervision management platform generates the UAV acquisition command, controls a UAV to travel to the first hazardous area, and performs flame feature analysis by inputting a real-time captured device image sequence into the feature recognition large model. If the flame feature is identified, the emergency supervision management platform dynamically determines the explosion risk of the first hazardous area based on the air flow rate, and simultaneously generate the valve closure command to remotely shut off the target valve(s) to cut off gas supply.

In some embodiments of the present disclosure, by real-time acquiring the gas output flow rate of the gas storage tank and the gas usage flow rate of the gas device through IoT technology, a potential first hazardous area can be quickly identified, achieving early warning of risks such as gas leakage. Through the UAV acquisition command, the UAV is quickly dispatched to the first hazardous area to obtain the device image sequence, avoiding delays and risks of manual inspections. Meanwhile, the feature recognition large model is utilized to analyze the device image sequence, enabling accurate identification of the flame feature and avoiding misjudgment or oversight. Determining the valve closure command based on the explosion risk and closing the target valve can effectively cut off the gas supply, reduce the possibility of an explosion or mitigate a damage caused by the explosion, thereby ensuring the safety of lives and property.

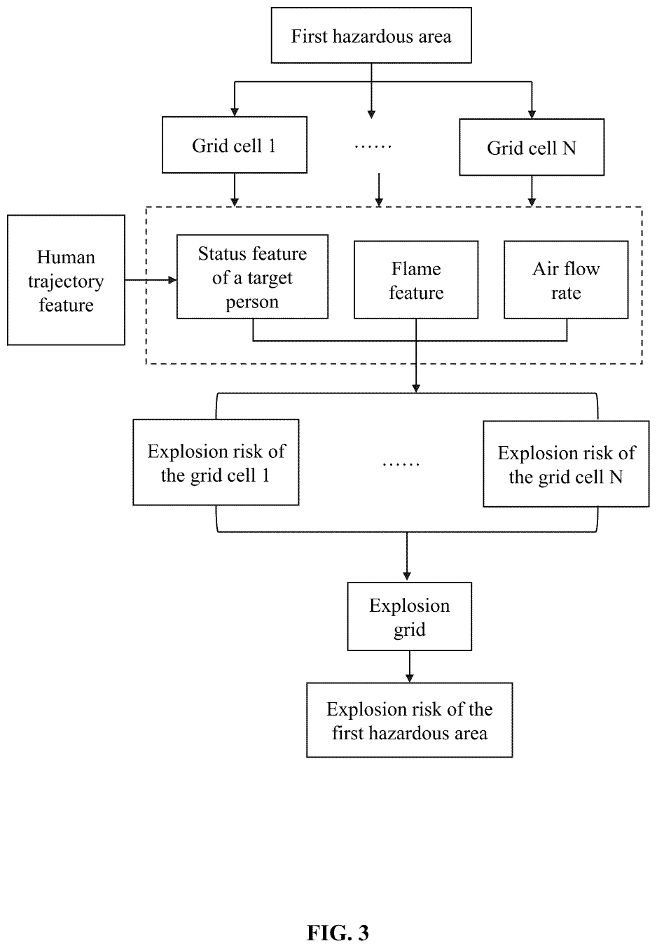

FIG. 3 is a schematic diagram illustrating an exemplary process for determining an explosion risk according to some embodiments of the present disclosure.

In some embodiments, the emergency supervision management platform is further configured to: perform gridding processing on the first hazardous area to obtain a plurality of grid cells; analyze a status feature of a target person based on a human trajectory feature; for a grid cell among the plurality of grid cells, determine an explosion risk of the grid cell based on the status feature of the target person in the grid cell, the flame feature, and the air flow rate; in response to the explosion risk of the grid cell being greater than a risk threshold, determining the grid cell as an explosion grid; and determine the explosion risk of the first hazardous area based on the explosion risk of the explosion grid.

A grid cell refers to an area unit obtained by further dividing the first hazardous area.

In some embodiments, a size of a grid cell may be preset based on experience.

In some embodiments, the size of the grid cell is positively correlated with a count of conscious persons in the first hazardous area and a normalized average distance among the conscious persons. For example, the emergency supervision management platform determines the size of the grid cell by querying a first preset table based on the count of conscious persons in the first hazardous area and the normalized average distance among the conscious persons. The first preset table contains predefined mappings between different combinations of the quantity of conscious persons and the normalized average distance, and the resulting size of the grid cell. The first preset table may be pre-constructed by a technician based on historical data.

A conscious person refers to a human whose corresponding human trajectory feature satisfies a preset feature condition.

The human trajectory feature of a person refers to a parameter feature for evaluating movement of the person in the first hazardous area. In some embodiments, the human trajectory feature includes a movement trajectory and a movement speed of the person, etc. In some embodiments, the human trajectory feature may be acquired through UAV collection.

In some embodiments, the preset feature condition may include: a fluctuation of the movement speed being less than a second threshold and/or a frequency of abrupt changes of the movement trajectory being less than the second threshold. The second threshold may be preset by a technician based on requirements. The fluctuation of the movement speed refers to a difference between speeds corresponding to two adjacent time points. An abrupt change of the movement trajectory is considered to have occurred if an angle between a movement direction at a current time point and a movement direction at a previous time point is greater than a preset angle value.

In some embodiments, the emergency supervision management platform may determine whether the human trajectory feature satisfies the preset feature condition based on an analysis of data collected by the UAV, thereby determining the count of conscious persons.

In some embodiments, the emergency supervision management platform may characterize a conscious state of the target person based on the status feature. For example, when the target person is in a conscious state, the status feature is 0; when the target person is in an unconscious state, the status feature is 1. The target person being in the unconscious state may include the target person being in a state of coma, drunk, etc., resulting in the target person being unable to effectively perform risk supervision duties.

The target person refers to each person in the first hazardous area.

In some embodiments, the emergency supervision management platform may obtain a distance between any two conscious persons in the first hazardous area, determine an average of all pairwise distances between the conscious persons, and then divide the average by a length of the first hazardous area to determine the normalized average distance among the conscious persons. The length of the first hazardous area may be a length of a line segment between two farthest points in the first hazardous area.

In some embodiments, in response to a large number of conscious persons in the first hazardous area and a small normalized average distance, which indicates a higher controllability of the state of the space in the first hazardous area, the size of the grid cell may be set larger to improve processing efficiency; conversely, the size of the grid cell may be set smaller to refine the space in the first hazardous area and more accurately determine the actual situation.

In some embodiments, the emergency supervision management platform may determine the explosion risk of the grid cell through a first preset algorithm based on the status feature of the target person in the grid cell, the flame feature, and the air flow rate. The air flow rate may include an average wind speed, a maximum wind speed, a wind speed change rate, a wind direction, a turbulence intensity, etc. In some embodiments, the air flow rate may be obtained through meteorological station data, a sensor mounted on the UAV, etc. More details regarding the flame feature and the explosion risk may be found in FIG. 2 and relevant descriptions thereof.

For example, the first preset algorithm may be an explosion risk prediction model for the grid cell. In some embodiments, the explosion risk prediction model may be a machine learning model. For example, the explosion risk prediction model includes any one or a combination of a Graph Neural Network (GNN) model or other custom model structures, etc.

In some embodiments, an input to the explosion risk prediction model may include a first grid graph, and an output of the explosion risk prediction model may be an explosion risk for each node in the first grid graph. The first grid graph may be composed of at least one node and at least one edge.

In some embodiments, one node corresponds to one grid cell in the first hazardous area. A node attribute of a node may include the status feature of the target person and the flame feature in the grid cell corresponding to the node.

In some embodiments, when two nodes correspond to adjacent grid cells, the nodes are connected by an edge, and an attribute of the edge includes an air flow rate between the two grid cells.

In some embodiments, the explosion risk prediction model may be obtained by training using a large number of second training samples with second labels. In some embodiments, the second training sample may include a sample first grid graph constructed based on data collected at a first historical time point, and the second label may be an explosion risk corresponding to each node of the sample first grid graph at a second historical time point. The first historical time point precedes the second historical time point, and a time interval between the first historical time point and the second historical time point may be preset.

In some embodiments, the second training sample may be obtained based on historical data. The second label may be determined based on whether an explosion accident actually occurred in the grid cell corresponding to each node of the sample first grid graph at the second historical time point. For example, when an explosion accident actually occurs in a grid cell, the emergency supervision management platform may locate an explosion position of the explosion accident through a monitoring image or a post-accident burn condition, and mark the explosion risk of the grid cell where the explosion position is located as 1. As another example, when no explosion accident occurs in a grid cell, the emergency supervision management platform may extract gas from the grid cell, detect a gas concentration, and determine the explosion risk of the grid cell by querying a second preset table to determine the value of the second label. The second preset table includes multiple sets of corresponding values for the gas concentration and the explosion risk. The second preset table may be pre-constructed by a technician based on experimental data.

A training process of the explosion risk prediction model is similar to the training process of the feature recognition large model, and reference may be made to the training process of the feature recognition large model.

The risk threshold refers to a standard value set for evaluating the explosion risk of the grid cell. The risk threshold may be set by a technician based on experience.

In some embodiments, the risk threshold may be related to a remaining gas storage amount of the gas storage in the first hazardous area. The higher the remaining gas storage amount of the gas storage in the first hazardous area is, the lower the risk threshold is.

The remaining gas storage amount refers to an amount of gas remaining in the gas storage tank at the current time point. The remaining gas storage amount may be obtained based on the emergency supervision object platform 150.

In some embodiments of the present disclosure, by dynamically associating the risk threshold with the remaining gas storage amount, the emergency supervision management platform can more accurately assess the explosion risk and realize more sensitive safety early warning.

The explosion grid refers to a grid cell with a high explosion risk. For example, the explosion grid includes a grid cell whose explosion risk is greater than the risk threshold. In some embodiments, the emergency supervision management platform may mark the explosion grid in a numerical form. For example, if a grid cell is determined to be the explosion grid, the grid cell is marked as 1; otherwise, the grid cell is marked as 0.

In some embodiments, the emergency supervision management platform may determine the explosion risk of the first hazardous area based on a plurality of explosion risks of a plurality of explosion grids. For example, an average or a maximum value of the plurality of explosion risks of the plurality of explosion grids is determined as the explosion risk of the first hazardous area.

In some embodiments, the emergency supervision management platform may determine the explosion risk of the first hazardous area based on a weighted value of the plurality of explosion risks of the plurality of explosion grids, wherein a weight of an explosion grid is related to a gas storage tank distribution in the explosion grid.

The gas storage tank distribution in an explosion grid refers to a configuration of gas storage tanks in the explosion grid, e.g., spatial positions and a count of gas storage tanks in the explosion grid.

In some embodiments, the more gas storage tanks an explosion grid contains, the greater the weight of the explosion grid is.

In some embodiments of the present disclosure, by dynamically associating the weight of an explosion grid with the gas storage tank distribution in the explosion grid, the emergency supervision management platform enables regional explosion risk assessment to more accurately reflect the distribution of the gas risk.

In some embodiments of the present disclosure, by performing the gridding processing on the first hazardous area, a risk assessment is refined to each grid cell, avoiding extensiveness of risk assessment for the entire area as a whole. Combining multi-dimensional data such as the status feature of the target person, the flame feature, and the air flow rate makes the risk assessment closer to the actual scenario. By marking the grid cell(s) whose explosion risk is greater than the risk threshold as the explosion grid(s), high-risk area(s) in the first hazardous area can be quickly and accurately located. Meanwhile, determining the explosion risk of the first hazardous area based on the explosion risk of the explosion grid can more comprehensively reflect an overall explosion risk status of the first hazardous area and improve accuracy of the risk assessment.

In some embodiments, the explosion risk of the first hazardous area is further related to a secondary explosion risk of the explosion grid. The emergency supervision management platform is further configured to determine the secondary explosion risk of the explosion grid based on a flammable material coverage rate in the explosion grid.

The secondary explosion risk refers to a probability of a subsequent explosion occurring in grid cells surrounding an explosion grid after an initial explosion occurs within the explosion grid.

The flammable material coverage rate of an explosion grid refers to a ratio of a total volume of flammable materials to a total spatial volume of the explosion grid.

In some embodiments, the emergency supervision management platform may determine the secondary explosion risk of the explosion grid through a second preset algorithm based on the flammable material coverage rate of the explosion grid. For example, the second preset algorithm may be a secondary explosion risk prediction model.

In some embodiments, the secondary explosion risk prediction model may be a machine learning model. For example, the secondary explosion risk prediction model may include any one or a combination of a Graph Neural Network (GNN) model or other custom model structures, etc.

In some embodiments, an input of the secondary explosion risk prediction model may include a second grid graph, and an output of the secondary explosion risk prediction model may be the secondary explosion risk of each node of the second grid graph. The second grid graph may be composed of at least one node and at least one edge.

In some embodiments, the second grid graph has the same nodes and edges as the first grid graph. The difference is that a node attribute of a node of the second grid graph may include the status feature of the target person, the flame feature, the explosion risk, an explosion grid attribute, and a target coverage rate in the grid cell corresponding to the node. The explosion grid attribute indicates whether the grid cell is an explosion grid. The target coverage rate refers to a flammable material coverage rate within a preset range of the grid cell.

The preset range corresponding to a grid cell is negatively correlated with a spatial openness value of the grid cell. The spatial openness value refers to a parameter that measures circulation or openness capability of the space within the grid cell.

In some embodiments, the spatial openness value is positively correlated with a weighted sum of: a distance between the grid cell and a solid obstacle (e.g., a wall, a load-bearing column, etc.), a distance between the grid cell and a secondary hazard source (e.g., an oil tank, a gas tank, a power line, a power device, etc.), and distances between the grid cell and a plurality of ventilation points. A weight for the distance between the grid cell and each ventilation point may be preset by a technician based on experience.

In some embodiments, the secondary explosion risk prediction model may be obtained by training with a large number of third training samples with third labels. In some embodiments, the third training sample may include a sample third grid graph constructed based on data collected at a first historical time point. The third label may be the secondary explosion risk of each node in the sample third grid graph at a third historical time point. The first historical time point is before the third historical time point, and a time interval between the first historical time point and the second historical time point is less than a time interval between the first historical time point and the third historical time point.

The acquisition manner of the third training sample is similar to the acquisition manner of the second training sample, and reference may be made to the related descriptions above.

The second label may be determined based on whether an explosion accident actually occurred in the grid cell corresponding to each node of the sample third grid graph at the third historical time point, and whether there is an edge directly connecting the grid cell where the explosion accident occurred and a grid cell marked as the explosion grid.

For example, if the grid cell marked as the explosion grid and at least one grid cell (hereinafter referred to as adjacent cell(s)) directly connected to the explosion grid via an edge actually experienced an explosion accident, the secondary explosion risk of the explosion grid is 1. As another example, if the grid cell marked as the explosion grid did not experience an explosion accident, or all adjacent cells of the grid cell marked as the explosion grid did not experience an explosion accident, the emergency supervision management platform may extract gas from the grid cell marked as the explosion grid and all the adjacent cells, detect the gas concentration in the grid cell marked as the explosion grid and each adjacent cell, and determine an average or a maximum value of the explosion risks of the grid cell marked as the explosion grid and all the adjacent cells by querying the second preset table to determine the value of the second label.

The training process of the secondary explosion risk prediction model is similar to the training process of the explosion risk prediction model, and reference may be made to the related descriptions above.

In some embodiments, the emergency supervision management platform may determine a first weighted value by calculating a weighted value of the plurality of explosion risks corresponding to a plurality of explosion grids, determine a second weighted value by calculating a weighted value of the plurality of secondary explosion risks corresponding to the plurality of explosion grids, and determine the explosion risk of the first hazardous area based on a weighted sum of the first weighted value and the second weighted value. Weights for parameters in each weighting operation may be set by a technician based on experience.

In some embodiments of the present disclosure, the introduction of the secondary explosion risk covers potential chain-reaction hazards within the first hazardous area, ensuring a more comprehensive and accurate risk assessment. By analyzing the flammable material coverage rate in the explosion grid, high-risk area(s) can be accurately identified, and targeted prevention and control measures can be taken in advance to reduce the probability and impact of accidents.

In some embodiments, the emergency supervision management platform is further configured to determine the explosion risk of the first hazardous area based on a weighted value of a plurality of explosion risks and a plurality of secondary explosion risks of a plurality of explosion grids, wherein a weight of the secondary explosion risk of an explosion grid is related to a count of firefighting devices in the explosion grid.

A firefighting device refers to a preset device in the explosion grid for firefighting. For example, the firefighting device includes a fire hydrant, a fire extinguisher, etc. In some embodiments, the larger the count of firefighting devices is, the greater a handling coverage of the explosion grid is. The handling coverage refers to a parameter measuring a capability to address firefighting problems in the explosion grid.

In some embodiments, the weight of the secondary explosion risk of a explosion grid is negatively correlated with the handling coverage of the explosion grid. For example, the greater the handling coverage of an explosion grid is, the smaller the weight of the secondary explosion risk of the explosion grid is.

In some embodiments of the present disclosure, by introducing a weighted evaluation mechanism that incorporates the explosion risk and the secondary explosion risk, and by correlating the weight of the secondary explosion risk with the count of firefighting devices, the actual distribution and response capability of firefighting resources are fully considered, making the risk assessment more practical and meaningful.

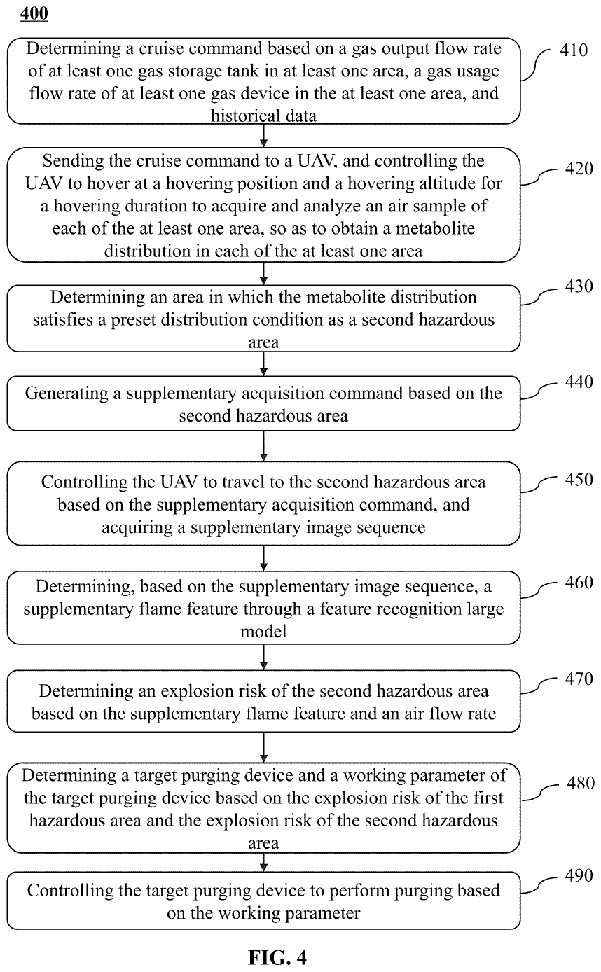

FIG. 4 is a flowchart illustrating an exemplary process for determining a target purging device according to some embodiments of the present disclosure. As shown in FIG. 4, a process 400 includes the following operations. In some embodiments, the process 400 may be performed by an emergency supervision management platform (e.g., the emergency supervision management platform 130).

In 410, a cruise command may be determined based on a gas output flow rate of at least one gas storage tank in at least one area, a gas usage flow rate of at least one gas device in the at least one area, and historical data.

More details regarding the gas output flow rate and the gas usage flow rate may be found in FIG. 2 and the relevant descriptions thereof.

The historical data refers to data from historical UAV cruise operations. In some embodiments, the historical data may be obtained from a database of the emergency supervision management platform.

The cruise command refers to a set of parameterized instructions for controlling a UAV to perform a cruise monitoring task. In some embodiments, the cruise command includes a hovering altitude, a hovering position, and a hovering duration.

In some embodiments, the emergency supervision management platform may determine the cruise command through various manners based on the gas output flow rate, the gas usage flow rate, and the historical data. For example, the emergency supervision management platform may determine the cruise command through vector matching in a vector database based on the gas output flow rate, the gas usage flow rate, and the historical data.

The emergency supervision management platform may, for each of the at least one area, construct a to-be-matched vector corresponding to the area based on a current gas output flow rate of a gas storage tank in the area and a current gas usage flow rate of a gas device within the area. The vector database includes a plurality of feature vectors and their corresponding labels. A feature vector is constructed based on the gas output flow rate of the gas storage tank and the gas usage flow rate of the gas device in a historical area. The label corresponding to a feature vector includes an actually adopted cruise command corresponding to the feature vector.

In some embodiments, the emergency supervision management platform, through a plurality of tests, screens out a cruise command that results in a lowest noise content of collected data from the historical data. The emergency supervision management platform constructs a feature vector based on the gas output flow rate of the gas storage tank in the area corresponding to the cruise command and the gas usage flow rate of the gas device in the area corresponding to the cruise command, and stores the feature vector in the vector database.

In some embodiments, the emergency supervision management platform may perform a vector similarity calculation between the to-be-matched vector and the feature vectors, designate a feature vector that satisfies a second preset condition as a target vector, and designate the label corresponding to the target vector as the cruise command. The second preset condition may be set based on actual requirements. For example, the second preset condition includes having a highest vector similarity, etc.

In 420, the cruise command may be sent to the UAV, and the UAV may be controlled to hover at the hovering position and the hovering altitude for the hovering duration to acquire and analyze an air sample of each of the at least one area, so that a metabolite distribution in each of the at least one area may be obtained.

The metabolite distribution refers to distribution features of various metabolites related to gas leakage or combustion in the air within an area. In some embodiments, the metabolite distribution includes a metabolite component and a concentration of the metabolite component. In some embodiments, the metabolite distribution may be obtained through a gas sensor, a portable gas detector, a sampling device mounted on the UAV, etc.

A metabolite refers to a pre-specified chemical component for collection. For example, the metabolite includes carbon monoxide, methane, etc.

In 430, an area in which the metabolite distribution satisfies a preset distribution condition may be determined as a second hazardous area.

The second hazardous area refers to a supplementary area requiring monitoring based on a first hazardous area. More descriptions regarding the first hazardous area may be found in related descriptions of FIG. 2

In some embodiments, the emergency supervision management platform may determine an area in which the metabolite distribution satisfies the preset distribution condition as the second hazardous area. The preset distribution condition may be that a concentration of a key metabolite component in the metabolite distribution is greater than a sixth threshold. The key metabolite refers to a metabolite produced from an interaction between an organism and gas. In some embodiments, the key metabolite may be preset by a technician based on requirements.

In some embodiments, for the second hazardous area, the emergency supervision management platform may determine a valve control command based on the metabolite distribution, and close a target valve based on the valve control command.

The valve control command refers to an operation command for controlling an opening or closing of the target valve. The target valve may be all or a portion of the gas valves in the second hazardous area.

In some embodiments, the emergency supervision management platform may determine the valve control command based on a metabolite distribution satisfying a first preset relationship.

The first preset relationship refers to a corresponding relationship between the metabolite distribution and the valve control command. For example, when the concentration of the key metabolite component is greater than a first trigger threshold, the emergency supervision management platform may designate a portion of the gas valves located at key positions in the second hazardous area as target valves. The key positions may be preset. When the concentration of the key metabolite component is greater than a second trigger threshold, the emergency supervision management platform designates all gas valves in the second hazardous area as the target valves.

In some embodiments of the present disclosure, the emergency supervision management platform, by dynamically generating the valve control command based on the metabolite distribution and precisely closing the target valve, achieves rapid gas cutoff in high-risk areas and effectively curbs spread of explosion risks.

In 440, a supplementary acquisition command may be generated based on the second hazardous area.

The supplementary acquisition command refers to a command for the UAV to perform supplementary acquisition of a target area.

In some embodiments, the emergency supervision management platform may determine the second hazardous area as the target area of the UAV, thereby generating the supplementary acquisition command.

In 450, the UAV may be controlled to travel to the second hazardous area based on the supplementary acquisition command, and acquire a supplementary image sequence.

The supplementary image sequence refers to a continuous image set obtained by arranging images of the gas device captured in the second hazardous area in chronological order.

The supplementary image sequence is similar to the device image sequence. More descriptions regarding the acquisition manner of the supplementary image sequence may be found in the acquisition manner of the device image sequence.

In 460, a supplementary flame feature may be determined through a feature recognition large model based on the supplementary image sequence.

More description regarding the feature recognition large model may be found in FIG. 2 and relevant descriptions thereof.

The supplementary flame feature refers to a flame feature characterizing the second hazardous area.

The supplementary flame feature is similar to the flame feature. More descriptions regarding the determination manner of the supplementary flame feature may be found in the determination manner of the flame feature.

In 470, an explosion risk of the second hazardous area may be determined based on the supplementary flame feature and the air flow rate.

The explosion risk of the second hazardous area is similar to the explosion risk of the first hazardous area. More descriptions regarding the determination manner of the explosion risk of the second hazardous area may be found in the determination manner of the explosion risk of the first hazardous area.

In 480, a target purging device and a working parameter of the target purging device may be determined based on the explosion risk of the first hazardous area and the explosion risk of the second hazardous area.

The target purging device refers to a device configured to remove impurities, pollutants, or residues in the target area through a gas flow (e.g., compressed air, inert gas, etc.). In some embodiments, the target purging device may include a high-pressure nitrogen purging device, etc.

In some embodiments, the working parameter of the target purging device include a nitrogen flow rate and a purging pressure.

In some embodiments, the emergency supervision management platform may determine a high-pressure nitrogen purging device in the first hazardous area and/or the second hazardous area where the explosion risk is not less than 0 as the target purging device based on the explosion risk of the first hazardous area and the explosion risk of the second hazardous area.

In some embodiments, the emergency supervision management platform may determine the working parameter of the target purging device by querying a third preset table. The third preset table includes multiple sets of corresponding values for the explosion risk, the nitrogen flow rate, and the purging pressure. The third preset table may be pre-constructed by a technician based on the historical data.

In some embodiments, the purging pressure of the target purging device in the first hazardous area is further related to a secondary explosion risk corresponding to the first hazardous area.

The greater the secondary explosion risk corresponding to the first hazardous area, the greater the purging pressure of the target purging device. The secondary explosion risk corresponding to the first hazardous area may be determined based on a secondary explosion risk corresponding to each grid cell in the first hazardous area. For example, the secondary explosion risk corresponding to the first hazardous area is an average, a maximum value, or a weighted value of secondary explosion risks corresponding to all grid cells included in the first hazardous area, where a weight of each grid cell may be preset.

In some embodiments of the present disclosure, the emergency supervision management platform achieves intelligent adjustment of a purging intensity by dynamically associating the purging pressure with the secondary explosion risk, thereby removing residual gas while avoiding secondary disasters caused by inappropriate pressure.

In 490, the target purging device may be controlled to perform purging based on the working parameter.

In some embodiments, the emergency supervision management platform may control the high-pressure nitrogen purging device in the first hazardous area and/or the second hazardous area to perform purging based on the working parameter at a position requiring purging.

In some embodiments of the present disclosure, based on the gas output flow rate, the gas usage flow rate, and the historical data, the cruise command suitable for a current environmental state can be intelligently generated to guide the UAV to perform precise hovering and air sample acquisition at the key positions, thereby improving accuracy and timeliness of hazardous area identification. By setting parameters such as the hovering altitude, the hovering position, and the hovering duration, it is ensured that the UAV can perform long-term stable sampling at positions where gas leakage or diffusion is most likely to occur, thereby obtaining more representative air samples. Furthermore, the second hazardous area is further identified through the supplementary acquisition command to ensure comprehensiveness of risk assessment. Meanwhile, the target purging device and its working parameter (e.g., the nitrogen flow rate and the purging pressure) are automatically determined based on a risk assessment result, thereby ensuring that the purging operation is efficient and targeted.

It should be noted that the above descriptions of the process 400 are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A system for emergency supervision of an open flame area in a smart city based on an Internet of Things (IoT) large model, the system comprising an emergency supervision management platform, wherein the emergency supervision management platform is configured to:
determine a first hazardous area based on a gas output flow rate of at least one gas storage tank and a gas usage flow rate of at least one gas device in at least one area;
generate an Unmanned Aerial Vehicle (UAV) acquisition command based on the first hazardous area;
control a UAV to travel to the first hazardous area based on the UAV acquisition command, and acquire a device image sequence;
determine, based on the device image sequence, a flame feature through a feature recognition large model, wherein the feature recognition large model is a machine learning model;
determine an explosion risk of the first hazardous area based on the flame feature and an air flow rate; and
determine a valve closure command based on the explosion risk, and close a target valve based on the valve closure command.

2. The system of claim 1, wherein the emergency supervision management platform is further configured to:
perform gridding processing on the first hazardous area to obtain a plurality of grid cells;
analyze a status feature of a target person based on a human trajectory feature;
for a grid cell among the plurality of grid cells, determine an explosion risk of the grid cell based on the status feature of the target person in the grid cell, the flame feature, and the air flow rate;
in response to the explosion risk of the grid cell being greater than a risk threshold, determine the grid cell as an explosion grid; and
determine the explosion risk of the first hazardous area based on the explosion risk of the explosion grid.

3. The system of claim 2, wherein the risk threshold is related to a remaining gas storage amount of a gas storage tank in the first hazardous area.

4. The system of claim 2, wherein the emergency supervision management platform is further configured to:
determine the explosion risk of the first hazardous area based on a weighted value of a plurality of explosion risks of a plurality of explosion grids, wherein a weight of an explosion grid is related to a gas storage tank distribution in the explosion grid.

5. The system of claim 2, wherein the explosion risk of the first hazardous area is further related to a secondary explosion risk of the explosion grid; and the emergency supervision management platform is further configured to:
determine the secondary explosion risk of the explosion grid based on a flammable material coverage rate in the explosion grid.

6. The system of claim 5, wherein the emergency supervision management platform is further configured to:
determine the explosion risk of the first hazardous area based on a weighted value of a plurality of explosion risks and a plurality of secondary explosion risks of a plurality of explosion grids, wherein a weight of the secondary explosion risk of an explosion grid is related to a count of firefighting devices in the explosion grid.

7. The system of claim 1, wherein the emergency supervision management platform is further configured to:
determine a cruise command based on the gas output flow rate, the gas usage flow rate, and historical data, wherein the cruise command includes a hovering altitude, a hovering position, and a hovering duration;
send the cruise command to the UAV, and control the UAV to hover at the hovering position and the hovering altitude for the hovering duration to acquire and analyze an air sample of each of the at least one area, so as to obtain a metabolite distribution in each of the at least one area;
determine an area in which the metabolite distribution satisfies a preset distribution condition as a second hazardous area;
generate a supplementary acquisition command based on the second hazardous area;
control the UAV to travel to the second hazardous area based on the supplementary acquisition command, and acquire a supplementary image sequence;
determine, based on the supplementary image sequence, a supplementary flame feature through the feature recognition large model;
determine an explosion risk of the second hazardous area based on the supplementary flame feature and the air flow rate;
determine a target purging device and a working parameter of the target purging device based on the explosion risk of the first hazardous area and the explosion risk of the second hazardous area, wherein the working parameter includes a nitrogen flow rate and a purging pressure; and
control the target purging device to perform purging based on the working parameter.

8. The system of claim 7, wherein the emergency supervision management platform is further configured to:
for the second hazardous area, determine a valve control command based on the metabolite distribution; and
close a target valve based on the valve control command.

9. The system of claim 7, wherein the purging pressure of the target purging device in the first hazardous area is further related to a secondary explosion risk corresponding to the first hazardous area.

10. A method for emergency supervision of an open flame area in a smart city based on an Internet of Things (IoT) large model, the method being executed by an emergency supervision management platform, and the method comprising:
determining a first hazardous area based on a gas output flow rate of at least one gas storage tank and a gas usage flow rate of at least one gas device in at least one area;
generating an Unmanned Aerial Vehicle (UAV) acquisition command based on the first hazardous area;
controlling a UAV to travel to the first hazardous area based on the UAV acquisition command, and acquiring a device image sequence;
determining, based on the device image sequence, a flame feature through a feature recognition large model, wherein the feature recognition large model is a machine learning model;
determining an explosion risk of the first hazardous area based on the flame feature and an air flow rate; and
determining a valve closure command based on the explosion risk, and closing a target valve based on the valve closure command.

11. The method of claim 10, wherein the determining an explosion risk of the first hazardous area based on the flame feature and an air flow rate includes:
performing gridding processing on the first hazardous area to obtain a plurality of grid cells;
analyzing a status feature of a target person based on a human trajectory feature;
for a grid cell among the plurality of grid cells, determining an explosion risk of the grid cell based on the status feature of the target person in the grid cell, the flame feature, and the air flow rate;
in response to the explosion risk of the grid cell being greater than a risk threshold, determining the grid cell as an explosion grid; and
determining the explosion risk of the first hazardous area based on the explosion risk of the explosion grid.

12. The method of claim 11, wherein the risk threshold is related to a remaining gas storage amount of a gas storage tank in the first hazardous area.

13. The method of claim 11, wherein the determining the explosion risk of the first hazardous area based on the explosion risk of the explosion grid includes:
determining the explosion risk of the first hazardous area based on a weighted value of a plurality of explosion risks of a plurality of explosion grids, wherein a weight of an explosion grid is related to a gas storage tank distribution in the explosion grid.

14. The method of claim 11, wherein the explosion risk of the first hazardous area is further related to a secondary explosion risk of the explosion grid; and the method further comprises:
determining the secondary explosion risk of the explosion grid based on a flammable material coverage rate in the explosion grid.

15. The method of claim 14, further comprising:
determining the explosion risk of the first hazardous area based on a weighted value of a plurality of explosion risks and a plurality of secondary explosion risks of a plurality of explosion grids, wherein a weight of the secondary explosion risk of an explosion grid is related to a count of firefighting devices in the explosion grid.

16. The method of claim 10, further comprising:
determining a cruise command based on the gas output flow rate, the gas usage flow rate, and historical data, wherein the cruise command includes a hovering altitude, a hovering position, and a hovering duration;
sending the cruise command to the UAV, and controlling the UAV to hover at the hovering position and the hovering altitude for the hovering duration to acquire and analyze an air sample of each of the at least one area, so as to obtain a metabolite distribution in each of the at least one area;
determining an area in which the metabolite distribution satisfies a preset distribution condition as a second hazardous area;
generating a supplementary acquisition command based on the second hazardous area;
controlling the UAV to travel to the second hazardous area based on the supplementary acquisition command, and acquiring a supplementary image sequence;
determining, based on the supplementary image sequence, a supplementary flame feature through the feature recognition large model;
determining an explosion risk of the second hazardous area based on the supplementary flame feature and the air flow rate;
determining a target purging device and a working parameter of the target purging device based on the explosion risk of the first hazardous area and the explosion risk of the second hazardous area, wherein the working parameter includes a nitrogen flow rate and a purging pressure; and
controlling the target purging device to perform purging based on the working parameter.

17. The method of claim 16, further comprising:
for the second hazardous area, determining a valve control command based on the metabolite distribution; and
closing a target valve based on the valve control command.

18. The method of claim 16, wherein the purging pressure of the target purging device in the first hazardous area is further related to a secondary explosion risk corresponding to the first hazardous area.

19. A non-transitory computer-readable storage medium, storing computer instructions, wherein when a computer reads the computer instructions in the storage medium, the computer executes a method for emergency supervision of an open flame area in a smart city based on an Internet of Things (IoT) large model, the method being executed by an emergency supervision management platform and comprising:
determining a first hazardous area based on a gas output flow rate of at least one gas storage tank and a gas usage flow rate of at least one gas device in at least one area;
generating an Unmanned Aerial Vehicle (UAV) acquisition command based on the first hazardous area;
controlling a UAV to travel to the first hazardous area based on the UAV acquisition command, and acquire a device image sequence;
determining, based on the device image sequence, a flame feature through a feature recognition large model, wherein the feature recognition large model is a machine learning model;
determining an explosion risk of the first hazardous area based on the flame feature and an air flow rate; and
determining a valve closure command based on the explosion risk, and closing a target valve based on the valve closure command.
